(19) United States
(12) Patent Application Publication
(10) Pub. No.: US 2005/0217616 A1
(43) Pub. Date: Oct. 6, 2005

(54) Engine

(76) Inventor: Tommy Chi Fai Po, Hong Kong (CN)

Correspondence Address: ALIX YALE & RISTAS LLP, 750 MAIN STREET, SUITE 1400, HARTFORD, CT, 06103, US

(21) Appl. No.: 10/813,804

(22) Filed: Mar. 30, 2004

(51) Int. Cl. F02B 75/22

(52) U.S. Cl. 123/54.3

(57) ABSTRACT

An engine has a block, an output shaft mounted to rotate within the block, a profiled cam attached to or formed integrally with the output shaft, a number of bores in the block extending in radial directions away from the output shaft, a respective reciprocating piston within each bore and defining an expansion volume within the bore at one side of the piston, a respective fixed push bar extending from each piston toward the output shaft, and inlet and exhaust ports communicating with the expansion volume. There is a valve at each inlet port, and a combustion manifold within which a pressurised fuel-air mixture ignites before entry via the inlet ports to the respective expansion volumes.

### BACKGROUND OF THE INVENTION

The present invention relates to combustion engines. More particularly, although not exclusively, the invention relates to a multi-cylinder radial engine receiving pre-combusted pressurised gas from a single combustion chamber.

Known multi-cylinder two-stroke or four-stroke internal combustion engines rely on combustion of an air-fuel mixture in the individual combustion chambers above each piston. This necessitates the provision of complex electro-mechanical and/or electronic spark-timing systems, carburettors or fuel injection and associated electronics, injectors and the like.

Another problem associated with known engine designs is in their requirement for specific fuel types depending on the engine itself. That is, engine designed to run on Diesel fuel will not run properly on petroleum and a two-stroke petroleum engine would fail after a short period of use on petroleum without the required concentration of oil either injected into the engine or mixed in with the fuel at the fuel source. Modern engines are even more fuel-particular—some requiring super grade petrol or Lead Replacement Petrol (LRP), some requiring unleaded or premium unleaded fuel, and others requiring Liquid Petroleum Gas (LPG) for example. Most all of these issues relate to compression ratio (pre-ignition suppression), valve design and timing, low emission requirements etc.

Where high-power requirements prevail, it is of course well-known to increase the size of the combustion chambers, or increase the number of cylinders. Multi-cylinder engines operating on the well-known crankshaft and connecting rod approach can be very space-inefficient. Although flat, radial and V-configurations reduce the overall length of a multi-cylinder engine, considerable crankshaft length in required as the connecting rods must not clash with one another and therefore must be spaced along the crankshaft at different positions.

### OBJECT OF THE INVENTION

It is an object of the present invention to overcome or substantially ameliorate at least one of the above disadvantages and/or more generally to provide an improved short-crankshaft, multi-cylinder combustion engine that can run on a wide range of fuel types including those made from mineral oil and synthetic fuels.

### DISCLOSURE OF THE INVENTION

There is disclosed herein an engine comprising:
a block,
an output shaft mounted to rotate within the block,
a profiled cam attached to or formed integrally with the output shaft,
a plurality of bores in the block extending substantially radially from the output shaft,
a respective reciprocating piston within each bore and defining an expansion volume within the bore at one side thereof,
a respective fixed push bar extending from each piston toward the output shaft and interacting with the profiled cam to effect rotation thereof, and
inlet and exhaust ports communicating with the expansion volume.

Preferably, the engine further comprises a valve at each inlet port.

Preferably, the engine further comprises a combustion manifold within which a pressurised fuel-air mixture ignites.

Preferably, the engine further comprises a compressor for compressing an air-fuel mixture within the manifold.

Preferably, the engine further comprises ignition means for igniting a fuel-air mixture within the combustion manifold.

Typically, the ignition means comprises a pilot light, glow plug or the like.

In one preferred configuration, the profiled cam comprises a plurality of circumstantially spaced lobes.

In some embodiments, each lobe has a convex side and a concave side.

In some embodiments, the push bar is offset so as not to point directly at the output shaft.

Preferably, the exhaust ports extended from a side of each bore at a position below that at which the respective piston minimises the expansion volume.

Preferably, the engine further comprises a roller or slider at an end of each connecting rod for rolling or sliding contact with the profiled cam.

### BRIEF DESCRIPTION OF THE DRAWINGS

Preferred forms of the present invention will now be described by way of example with reference to the accompanying drawings, wherein:

FIG. 1 is a schematic diagram illustrating an engine comprising four pistons and associated expansion volumes—each receiving already-combusting fuel-air mixture from a common combustion manifold,

FIG. 2 is a schematic cross-sectional elevation of a six-radial piston combustion engine,

FIGS. 3, 4, 5 and 6 are schematic cross-sectional elevations of just parts of the engine of FIG. 2 in various rotational phases of operation,

FIGS. 7. 8 and 9 are schematic partial elevations of an alternative engine in which the pistons and push bars are offset from the output shaft,

FIG. 10 is a schematic elevation of a three-lobed profiled cam, and

FIG. 11 is a schematic elevation of a four-lobed profiled cam.

### DESCRIPTION OF THE PREFERRED EMBODIMENTS

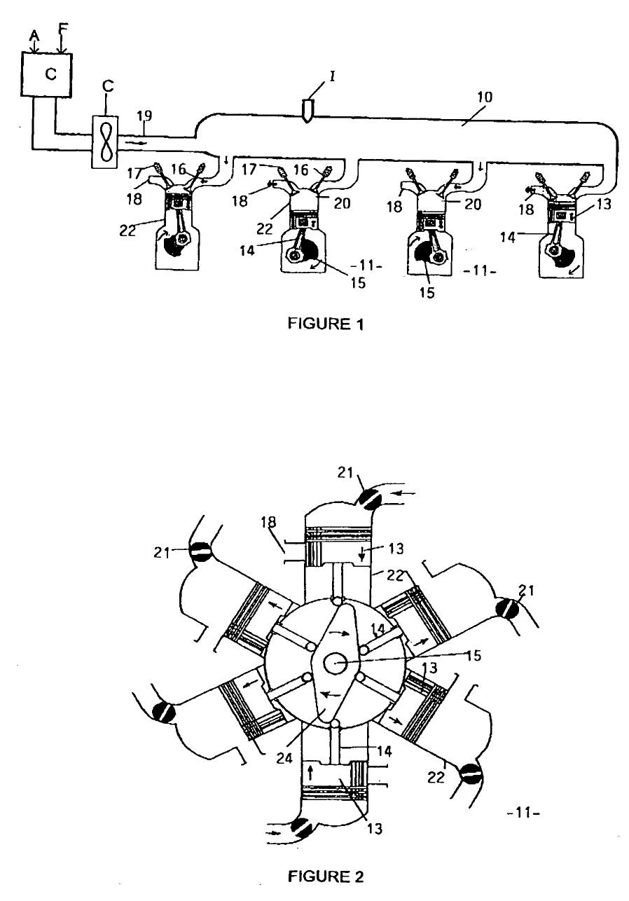

In FIG. 1 of the accompanying drawings there is depicted schematically an engine comprising a block 11 having a number of bores 22 each having a reciprocating piston therein. Note in this drawing that each piston is shown connected by a conventional connecting rod 14 to a crankshaft 15. Note also in thin drawing that conventional inlet and exhaust valves 16 and 17 of the type that might be employed in a four-stroke engine are depicted.

Above each piston 13, there is an expansion volume 20.

Provided upstream of, and in communication with each expansion volume 20 is a combustion manifold 10. A mixture of gas and air ignites within the combustion manifold 10. Upstream of the combustion manifold 10 there is a compressor C delivering a fuel-air mixture (F+A) combined in a carburettor C via a delivery port 19 to the combustion manifold 10. The volatile mixture within the manifold 10 is ignited by an igniter I. Igniter I might be a glow plug, spark emitter, pilot light or the like. The compressor C maintains a relatively constant positive pressure within the combustion manifold 10.

As shown in FIG. 2, the engine would typically be formed in a radial manner—ie. having a plurality of bores 22 extending radially away from a output shaft 15. Attached to or formed integrally with the output shaft 15 is a profiled cam having lobes 24.

Within each bore 22 there is a piston 13 having a fixed push bar 14 depending therefrom. The push bar 14 is not attached to the piston 13 with a gudgeon pin as would be the case with a conventional piston and connecting rod. Instead, the pushrod 14 is rigidly secured to the piston 13 so that it always extends directly toward the output shaft 15. The push bar 14 has a roller or smooth sliding tip 25 in that bears against the profiled cam. That is, interaction of the push bar 14 with the surface of the cam is either a rolling contact or a sliding contact. The provision of a single profiled cam makes for a very short output shaft 15, as compared to what would be required with a conventional crankshaft, as each push bar bears upon the profiled cam in the same plane. Moreover, all of the bores and pistons are co-planar.

There is a valve 21 at the inlet port 23—separating the inlet port 23 from the expansion volume 20 above the piston 13. The valves 21 are to be operated by computer or mechanical control to open and close in a desired sequence and timing.

There is an exhaust port 18 at the side of each bore 22 to exhaust spent gases during the end part of, or after the down-stroke of the piston 13.

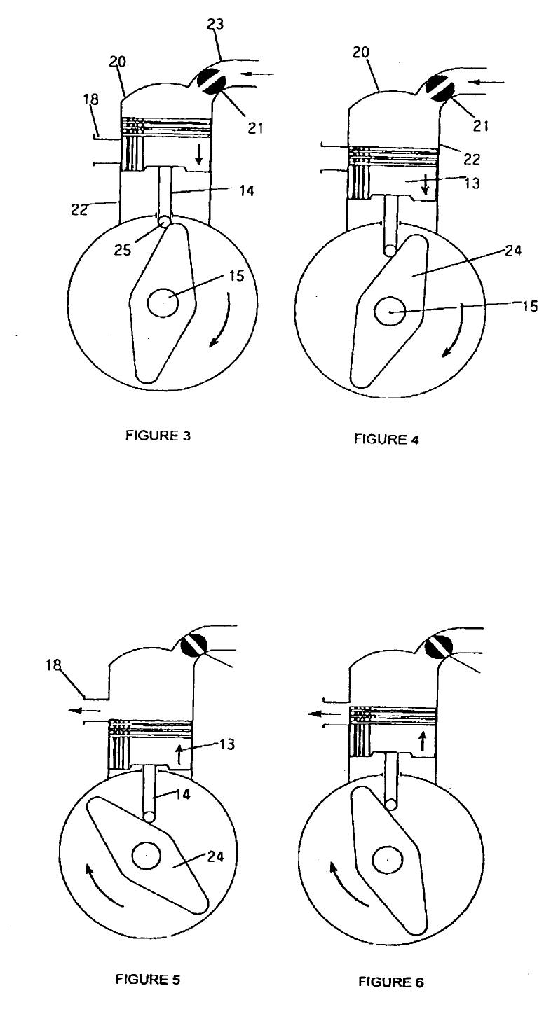

A number of rotational positions of the profiled cam (having lobes 24) are depicted in FIGS. 3 to 6. As shown in FIG. 3, the valve 21 is opened to enable the ingress of high-pressure combusting gases into the expansion volume 20. As the combustion gases further expand within the expansion volume 20, the piston 13 is forced downwardly so that the roller or sliding tip 25 in roles or slides along the profiled cam to cause it to turn in a clockwise sense. Prior to and during the up-stroke as shown in FIG. 5, spent gas is exhausted via the exhaust port 18 and the profiled cam pushes the push bar 14 and thus the piston 13 to its uppermost position.

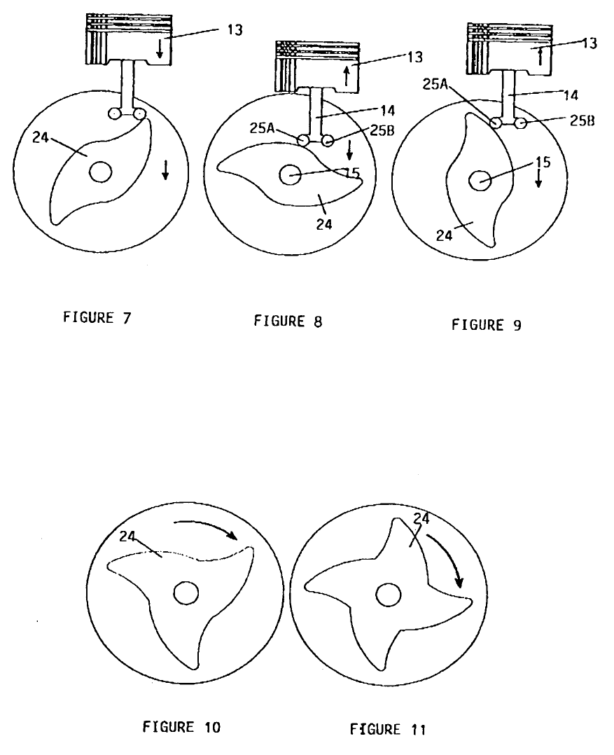

Various modifications to the engine design are depicted in FIGS. 7 to 11. In FIGS. 7 to 9, one of the radially extending pistons is depicted. However, it should be noted that there would be other such pistons generally radiating from the output shaft 15. In this embodiment however, the pistons 13 and push bars 14 are slightly offset, rather than radiating directly from the output shaft 15. This is believed to be conducive to increased efficiency. Also, the lobes of the profiled cam are slightly scalloped—having a concave side and a convex side. Also, instead of a single roller, there are dual rollers or smooth tips as 25A and 25B affixed to the end of the push bar 14. Either roller (or smooth tip) 25A or 25B engages the surface of the profiled cam—depending upon the rotational position of the cam.

Three-lobe and four-lobe profiled cams are shown in FIGS. 10 and 11 respectively. The number of lobes on the profiled cam determines the number of reciprocations of the piston 13 required to achieve a single revolution of the output shaft. Also, the number of lobes affects the output torque of the engine.

The power output of the engine can be increased by increasing gas pressure within the combustion manifold. This might be done by pumping more air and fuel into the manifold.

It should be appreciated that modifications and alterations obvious to those skilled in the art are not to be considered as beyond the scope of the present invention. For example the profiled cam might be provided with a capture slot extending the whole way around it to retain the distant end of the push bar to prevent any bounce that might otherwise be induced between the push bar and the cam surface.

1. An engine comprising:
a block,
an output shaft mounted to rotate within the block,
a profiled cam attached to or formed integrally with the output shaft,
a plurality of bores in the block extending substantially radially from the output shaft,
a respective reciprocating piston within each bore and defining an expansion volume within the bore at one side thereof,
a respective fixed push bar extending from each piston toward the output shaft and interacting with the profiled cam to effect rotation thereof, and
inlet and exhaust ports communicating with the expansion volume.

2. The engine of claim 1, further comprising a valve at each inlet port.

3. The engine of claim 1, comprising a combustion manifold within which a pressurized fuel-air mixture ignites.

4. The engine of claim 2, further comprising a compressor for compressing an air-fuel mixture within the manifold.

5. The engine of claim 2, further comprising ignition means for igniting a fuel-air mixture within the combustion manifold.

6. The engine of claim 4, wherein the ignition means comprises a pilot light.

7. The engine of claim 1, wherein the profiled cam comprises a plurality of circumferentially spaced lobes.

8. The engine of claim 6, wherein each lobe has a convex side and a concave side.

9. The engine of claim 1, wherein the push bar is offset so as not to point directly at the output shaft.

10. The engine of claim 1, wherein the exhaust ports extend from a side of each bore at a position below that at which the respective piston minimizes the expansion volume.

11. The engine of claim 1, further comprising a roller at an end of each connecting rod for rolling contact with the profiled cam.

12. The engine of claim 10, further comprising a pair of said rollers an end of each connecting rod.

13. The engine of claim 1, further comprising a slider at an end of each connecting rod for sliding contact with the profiled cam.

14. The engine of claim 12, further comprising a pair of sliders at an end of each connecting rod.

15. The engine of claim 4, wherein the igniter means comprises a glow plug.

16. The engine of claim 4, wherein the fuel/air mixture is ignited once and continues to glow so long as air and fuel is delivered to the combustion manifold.
